(19) United States
(12) Patent Application Publication
(10) Pub. No.: US 2018/0326656 A1
(43) Pub. Date: Nov. 15, 2018

(54) DEVICE FOR PRODUCING THREE-DIMENSIONAL OBJECTS

(71) Applicant: CL SCHUTZRECHTSVERWAL TUNGS GMBH, Lichtenfels (DE)

(72) Inventors: Frank HERZOG, Lichtenfels (DE); Florian BECHMANN, Lichtenfels (DE); Fabian ZEULNER, Lichtenfels (DE)

(73) Assignee: CL SCHUTZRECHTSVERWAL TUNGS GMBH, Lichtenfels (DE)

(21) Appl. No.: 15/774,988

(22) PCT Filed: Nov. 24, 2016
(86) PCT No.: PCT/EP2016/078654

§ 371 Date: May 9, 2018

(30) Foreign Application Priority Data
Dec. 21, 2015 (DE) 10 2015 122 460.7

(51) Int. Cl. B29C 64/153; B29C 64/255; B29C 64/268

(52) U.S. Cl. CPC B29C 64/153; B33Y 30/00; B29C 64/268; B29C 64/255

(57) ABSTRACT

A device 1 for producing three-dimensional objects 2 by the successive solidifying of layers of a powdery, structural material 3 that is solidifiable by means of radiation, in particular electromagnetic radiation or particle radiation, at the points corresponding to the respective cross section of the object, in particular an SLM device or an SLS device having a housing 7, in which a process chamber 8 and at least one building chamber 5, 6 are disposed, having a supporting means 9 for supporting the object 2 inside the building chamber 5, 6, a metering chamber 4 for storing the structural material 3, a coating device 10 for applying the structural material 3 and an irradiation device 11 for irradiating the applied layers of the structural material 3.

### CROSS-REFERENCE TO RELATED APPLICATIONS

This application is a United States national stage entry of an International Application serial no. PCT/EP2016/078654 filed Nov. 24, 2016 which claims priority to German Patent Application serial no. 10 2015 122 460.7 filed Dec. 21, 2015. The contents of these applications are incorporated herein by reference in their entirety as if set forth verbatim.

### DESCRIPTION

The invention relates to a device for producing three-dimensional objects by the successive solidifying of layers of a powdery, structural material that is solidifiable by means of radiation or particle radiation, at the points corresponding to the respective cross section of the object, in particular a generative laser sintering or laser melting device.

Known devices of this type have a housing, in which a process chamber and a building chamber are disposed. Provided inside the building chamber is a height-adjustable supporting means for supporting the object, and in addition a metering chamber for storing the structural material is disposed in most cases next to the building chamber. A coating device is used for applying the structural material, and an irradiation means is used for irradiating the applied layers of the structural material inside the building chamber, wherein the coating device is supported so as to be capable of being displaced back and forth at least over the building chamber, for which purpose the coating device is supported at least unilaterally in a guiding means.

A suchlike device is known, for example, from DE 10 2012 012 412. There, the guiding means for the coater is disposed in the lateral region of the process chamber.

It is known in principle from other technical fields to configure guiding elements for technical apparatuses and devices, for example X-ray machines in a room for X-ray examinations, as a gantry and to arrange a suchlike gantry either as a floor-mounted structure or also suspended beneath a ceiling of the room. Suspended gantry arrangements have not yet gained acceptance in the field of generative production technology.

The invention has as its object to configure a device having the characterizing features of the preamble to the claims in such a way that the building fields in the region of the process chamber can be configured flexibly on the respective building job. This object is accomplished in that the guiding devices for a coater device or other elements that is capable of displacement inside the process chamber is configured as a gantry arranged in the ceiling area of the process chamber, in particular of suspended configuration, in particular as a multiple gantry.

A suspended gantry in the region of a process chamber of a generative building device, such as an SLM device or an SLS device, is particularly advantageous in the respect that the building area of a process chamber can be kept completely free of guiding elements, on which coaters, scanners, sensors, diode arrays, powder feeds, powder extractors or other cleaning elements for the building chamber and the process chamber, air injector nozzles and the like can be disposed so as to be capable of free displacement. Because of the overhead configuration of the gantry in the ceiling area of the building chamber, the bottom building chamber region remains freely accessible, and supports, strut elements or elongated guiding elements can be dispensed with in the floor of the process chamber or in the lateral region of the building chamber. The guiding elements are situated in the upper region of the building chamber and are consequently also relatively easily accessible for servicing purposes.

The gantry in an advantageous further development of the invention can be configured in a complex manner as a multiple gantry and can exhibit a plurality of guiding regions disposed above one another or next to one another for different elements that are capable of displacement independently of one another. It is also possible in principle to displace different elements, such as a camera and a sensor, separately in one and the same guiding element, for example the camera from a left-hand side of the gantry over the entire gantry range of travel and a sensor from the right-hand side of the gantry over an entire range of travel of the gantry.

The gantry can also be exchangeably disposed in the ceiling area of the process chamber. In particular, a gantry insertion technique or suspension technique is offered, such that a gantry in the region of a process chamber can be adapted to the respective guiding and attachment requirements of the building job concerned. The gantry can also be disposed displaceably beneath the ceiling area of the process chamber, i.e. it can be displaced according to need to the left, to the right, pushed to the front or to the rear or can even be configured so as to be capable of being withdrawn outwards in the manner of a drawer through an opening in the process chamber or of being lifted upwards through a ceiling opening in the process chamber, on the one hand in order for it to be freely accessible for servicing purposes, but on the other hand for it also to be free for equipping with sensor modules, coater modules and the like. If a gantry is designed to be completely removable from a process chamber, it can then also be used as a “change gantry” in another process chamber.

The gantry can be disposed advantageously so as to be capable of rotation at least partially beneath the ceiling area of the process chamber, and one or a plurality of change/installation modules or elements that are capable of different displacement can be disposed on the gantry. The change/installation modules can be perforated plates, for example, which are disposed in a slidable and automatically displaceable manner on the gantry, but which are configured in such a way that sensors, cameras, scanners, cleaning elements, coaters and the like can be positioned there in a simple manner.

The gantry as a whole, or at least a section thereof, can be disposed in a non-horizontal position or can be brought into a non-horizontal position. In other words, a gantry for particular purposes can also be disposed obliquely beneath the ceiling of the building space, if the building job makes this appear to be advantageous. The gantry can constitute a basic gantry, on which one or a plurality of sub-gantries or change gantries are disposed. This results in a complex sliding system for the mounting of different elements beneath the ceiling, so that each point of the building field can be positioned independently of one another by different elements as the need arises. The at least one sub-gantry or change gantry can be disposed displaceably, rotatably, tiltably and the like on the basic gantry.

The sub-gantries or change gantries can be distributed or disposed in a distributable manner in groups over the surface of the building space.

The guiding elements of a plurality of gantries can be disposed inside one another in such a way that elements guided thereon that are capable of displacement back and forth in the process chamber are capable of displacement over the entire region of the process chamber.

It can be of considerable advantage, furthermore, if the ceiling area of the process chamber above the gantry is of upwardly foldable or removable configuration, such that the gantry is freely accessible from above. It is also useful, where appropriate, to mount the gantry so that it is likewise capable of being folded out upwards from the resulting ceiling opening, such that—as already mentioned below—it is readily accessible for the purpose equipping it with new or other modules.

The invention is explained in more detail on the basis of illustrative embodiments.

In these embodiments:

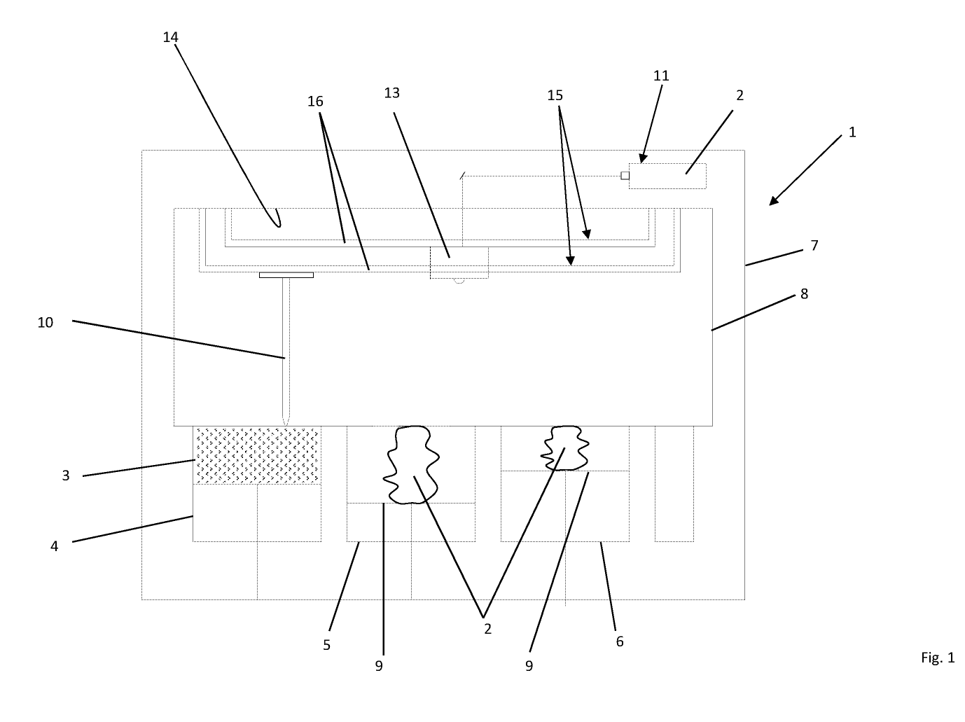

FIG. 1 depicts a schematic cross-sectional representation of an inventive device having a metering chamber, two building chambers, an overflow container and a suspended gantry having a plurality of guiding regions disposed beneath the ceiling area;

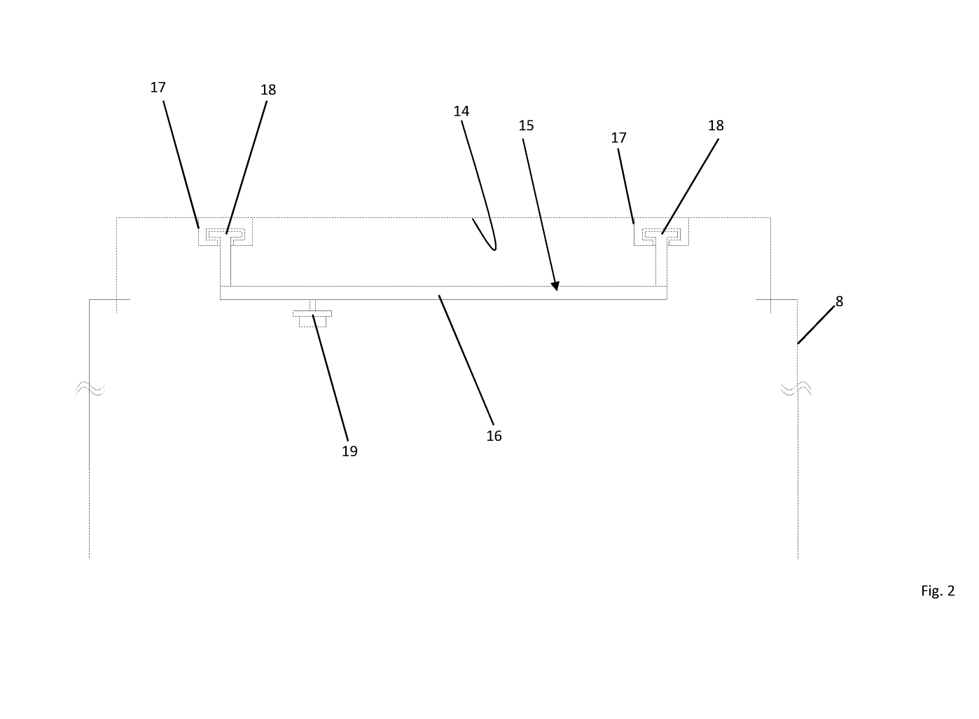

FIG. 2 depicts a schematic partial cross-sectional representation of a ceiling area of a process chamber of an inventive device according to FIG. 1 having a suspended gantry, which is disposed exchangeably and displaceably;

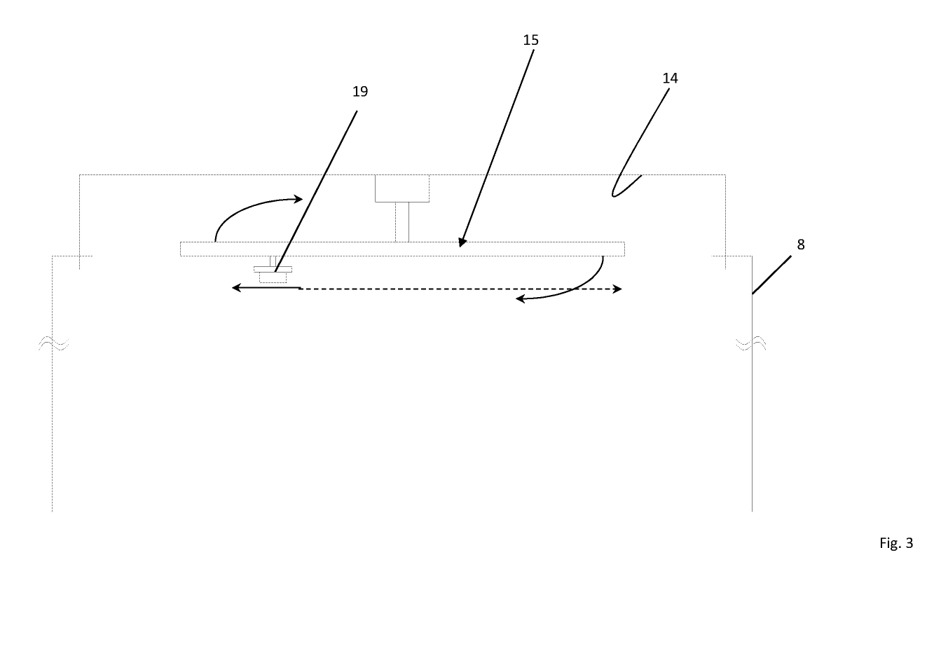

FIG. 3 depicts a schematic partial cross-sectional representation of a ceiling area similar to FIG. 2, having a suspended, rotatably disposed gantry;

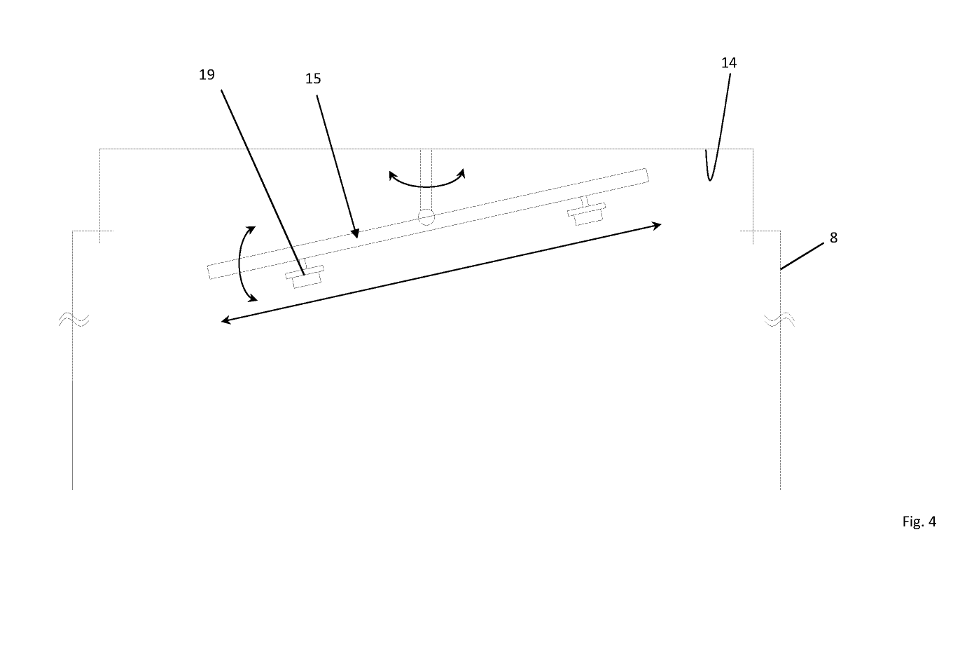

FIG. 4 depicts a partial cross-sectional representation through a ceiling area similar to FIGS. 2 and 3 having a suspended, rotatable and tiltable gantry;

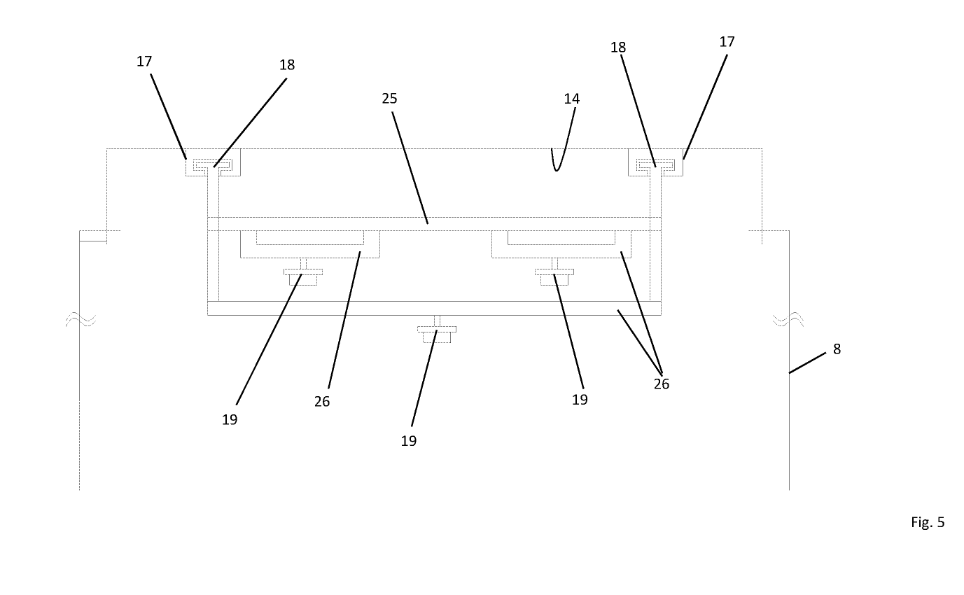

FIG. 5 depicts a schematic partial cross-sectional representation of a ceiling area of an inventive device having a suspended basic gantry and a plurality of sub-gantries;

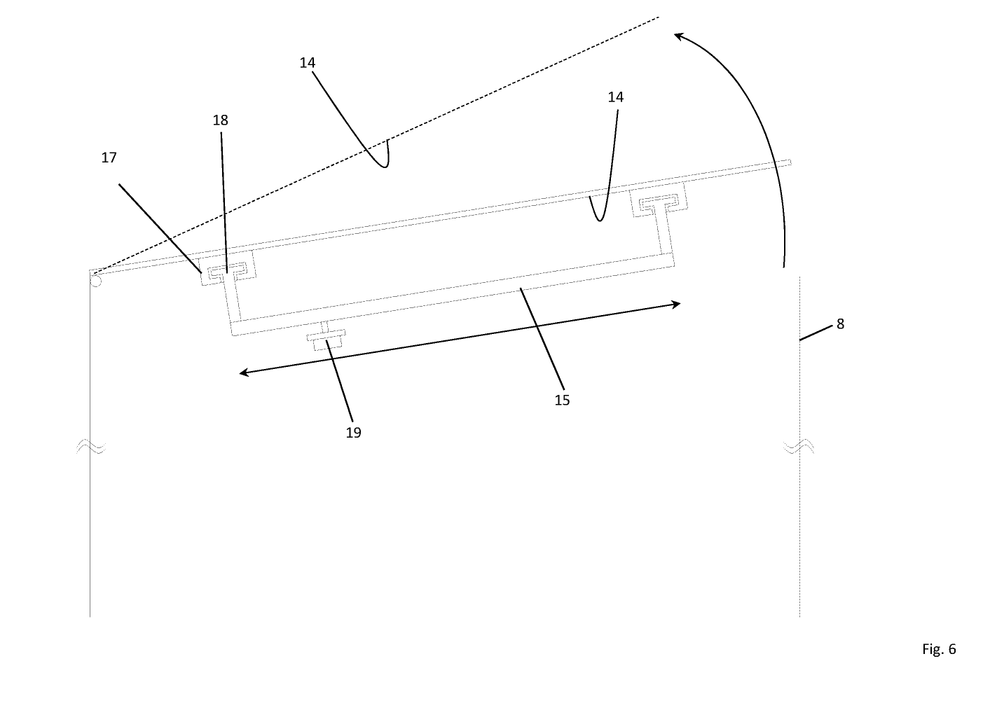

FIG. 6 depicts a schematic representation from the side of an inventive device, in which the ceiling area of the process chamber can be folded upwards and a suspended gantry is disposed on the upwardly folded ceiling area;

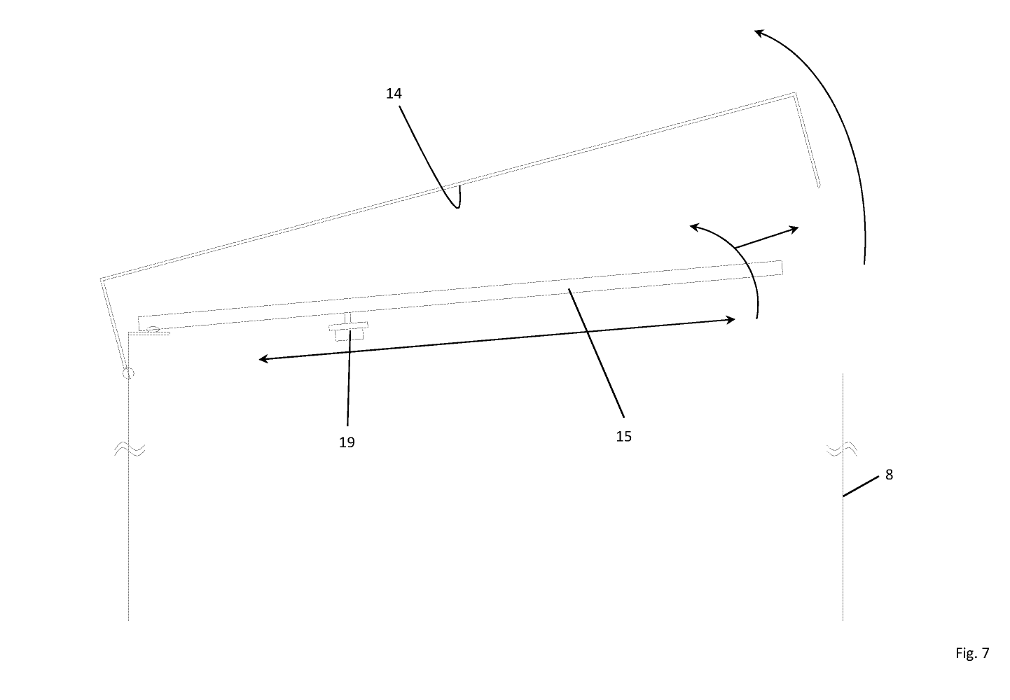

FIG. 7 depicts a representation similar to FIG. 6, wherein the ceiling area of the process chamber can be folded upwards and a gantry capable of being folded up separately can be folded outwards through the resulting ceiling opening.

The device 1 schematically represented in the figures in the drawings is used for producing three-dimensional objects 2 by the successive solidifying of layers of a powdery, structural material 3 that is solidifiable by means of radiation or particle radiation, which material is held in readiness in a metering chamber 4 of the device 1. The building process takes place in two building chambers 5, 6, wherein a device having only one building chamber or having more than two building chambers likewise lies within the scope of the invention.

Customary devices of this kind exhibit a housing 7, in which a process chamber 8 are disposed with the building chambers 5 and 6. A supporting means, which is of height-adjustable configuration and can be moved downwards in the course of the building process, is allocated to the building chambers 5, 6 in each case. The structural material 3 from the metering chamber 4 is applied by means of a coating device 10 in layers inside the building chambers 5, 6 and is caused to melt by an irradiation device 11, for example comprising a laser 12 and a scanner 13, such that the object 2 is produced after cooling and curing of the melt.

Disposed in the ceiling area 14 of the process chamber 8 is a suspended gantry 15, which has a guiding device, for example for the coating device 10, a scanner 13 that is capable of displacement, or further elements that are capable of displacement, for example sensors, powder feeds, diode arrays, powder extractors, air injector nozzles, etc., that can be disposed in a freely displaceable manner.

It is possible in principle, on a gantry 15, to provide a plurality of guiding regions 16 disposed above one another or disposed next to one another for different movable elements of the aforementioned kind.

It can be appreciated from the illustrative embodiment represented in FIG. 2 that the gantry 15 is arranged exchangeably in the ceiling area 14 of the process chamber 8. Guiding rails 17, into which the holding elements 18 can be inserted, are attached to the underside of the ceiling for this purpose directly in the ceiling area, such that the gantry 15 beneath the ceiling area 14 of the process chamber 8 is displaceable as a whole or is capable of being withdrawn outwards in the manner of a drawer through an opening in the process chamber 8. The guiding rails 17 and the holding elements 18 of the gantry can be similarly configured by drawer guides.

In the illustrative embodiment represented in FIG. 3, it can be appreciated that the gantry 15 is disposed so as to be capable of being rotated at least partially beneath the ceiling area 14 of the process chamber. One or a plurality of change/installation modules 19 can also be provided within the scope of the invention in a displaceable manner on the gantry 15, wherein the change/installation modules 19 are perforated plates or elements provided with snap-action latching connections, for example, such that sensors, scanners and the like can be provided in a simple manner on the change/installation modules 19.

In the illustrative embodiment represented in FIG. 4, furthermore, it can be seen that the gantry 15 or at least sections of the gantry 15 can be tilted into a non-horizontal position or can be disposed from the outset in a suchlike inclined position.

FIG. 5 depicts a more complex configuration of a gantry 15, which consists of a basic gantry 25 and a plurality of sub-gantries or change gantries 26. The basic gantry 25 is configured in such a way that it is able to carry a plurality of sub-gantries or change gantries 26, which can themselves also be disposed displaceably on the basic gantry 25. Different elements such as sensors, coaters, scanners, extractors and the like are then in turn disposed displaceably on the change gantries or sub-gantries 26, for example over the aforementioned installation modules. This combination of at least one basic gantry and a plurality of change gantries or sub-gantries 26 results in a multiplicity of installation and displacement possibilities for elements that are movable or displaceable independently of one another, for example sensor elements, scanners, coaters and the like.

The sub-gantries or change gantries 26 can also be positioned rotatably or tiltably in each case on the basic gantry 25 according to FIGS. 3 and 4. Change gantries or sub-gantries 26 can be disposed in a manner in which they are distributed or are capable of being distributed over the surface of the building space 8 or also the process chamber 8. The basic gantry 25 or the plurality of gantries and/or change gantries or sub-gantries 26 are capable of adjustment by a motor, such that a process-controlled automatic adjustment of the gantries 15, 25 and the elements attached thereto is possible.

FIGS. 6 and 7 depict two embodiments, in which the ceiling area 14 of the process chamber 8 is configured in an upwardly foldable manner, such that either a gantry 15 attached to the ceiling area (FIG. 6) is folded up with the ceiling area 14 and is then exposed for servicing purposes or for re-equipment with suitable elements or, according to FIG. 7, the ceiling area 14 is folded up separately and the gantry 15 can then be folded up separately. It should be noted that each gantry in FIG. 1, in FIG. 2 and FIGS. 6 and 7 can be configured displaceably, rotatably, tiltably, as a single gantry or a multiple gantry, as a basic gantry having sub-gantries and the like. For the sake of simplicity, it has been resolved not to represent a basic gantry having sub-gantries, for example in FIGS. 6 and 7. It is nevertheless within the scope of the invention to provide suchlike complex gantries beneath a folding cover, wherein the ability of these gantries to rotate and to tilt also lies within the scope of the invention.

### LIST OF REFERENCE DESIGNATIONS

1 device
2 object
3 structural material
4 metering chamber
5 building chamber
6 building chamber
7 housing
8 process chamber
9 supporting means
10 coating device
11 irradiation device
12 laser
13 scanner
14 ceiling area
15 gantry
16 guiding region
17 guiding rails
18 holding elements
19 change/installation module
25 basic gantry
26 sub-gantries or change gantries

1. A device (1) for producing three-dimensional objects (2) by the successive solidifying of layers of a powdery, structural material (3) that is solidifiable by means of radiation, in particular electromagnetic radiation or particle radiation, at the points corresponding to the respective cross section of the object, in particular an SLM device or an SLS device having a housing (7), in which a process chamber (8) and at least one building chamber (5, 6) are disposed, having a supporting means (9) for supporting the object (2) inside the building chamber (5, 6), a metering chamber (4) for storing the structural material (3), a coating device (10) for applying the structural material (3) and an irradiation device (11) for irradiating the applied layers of the structural material (3), wherein the coating device (10) is supported so as to be capable of displacement back and forth at least over the building chamber (5, 6), for which purpose the coating device (10) is supported at least unilaterally in a guiding means, characterized in that the aforementioned guiding device and/or a further guiding device for further elements that are capable of displacement inside the process chamber (8) is configured in particular as a suspended gantry (15, 25) disposed in the ceiling area (14) of the process chamber (8).

2. The device as claimed in claim 1, characterized in that the gantry (15, 25) has a plurality of guiding regions disposed above one another or next to one another for different moving elements.

3. The device as claimed in claim 1, characterized in that the gantry (15, 25) is disposed exchangeably in the ceiling area (14) of the process chamber (8).

4. The device as claimed in claim 1, characterized in that the gantry (15, 25) is disposed displaceably beneath the ceiling area (14) of the process chamber (8).

5. The device as claimed in claim 4, characterized in that the gantry (15, 25) is configured so as to be capable of being withdrawn outwards in the manner of a drawer in particular through an opening in the process chamber (8).

6. The device as claimed in claim 1, characterized in that the gantry (15, 25) is disposed so as to be capable of being rotated at least partially beneath the ceiling area (14) of the process chamber (8).

7. The device as claimed in claim 1, characterized in that one or a plurality of change/installation modules (15) for different elements that are capable of displacement are disposed on the gantry (15, 25).

8. The device as claimed in claim 1, characterized in that the gantry (15, 25) in its entirety or sections of the gantry are disposed in a non-horizontal position or are capable of being brought into such a position.

9. The device as claimed in claim 1, characterized in that the gantry constitutes a basic gantry (25), on which one or a plurality of sub-gantries or change gantries (26) are disposed.

10. The device as claimed in claim 9, characterized in that the at least one sub-gantry or change gantry (26) is disposed displaceably, rotatably or tiltably on the basic gantry (25).

11. The device as claimed in claim 1, characterized in that the sub-gantries or change gantries (26) are disposed in groups that are distributed or are capable of being distributed over the surface of the building space.

12. The device as claimed in claim 1, characterized in that the guiding elements of a plurality of gantries (15, 25) are disposed inside one another in such a way that elements guided thereon that are capable of displacement back and forth in the process chamber (8) are capable of displacement over the entire region of the process chamber (8).

13. The device as claimed in claim 1, characterized in that the gantry (15, 25) and/or the at least one change gantry (26) is capable of adjustment by a motor.

14. The device as claimed in claim 1, characterized in that the ceiling area (14) of the process chamber (8) above the gantry (15, 25) is of upwardly foldable or removable configuration.

15. The device as claimed in claim 14, characterized in that the gantry (15, 25) is supported so as to be capable of being folded outwards through the opened ceiling area (14) of the process chamber (8).
